(19) United States
(12) Patent Application Publication
(10) Pub. No.: US 2026/0004621 A1
(43) Pub. Date: Jan. 1, 2026

(54) METHOD AND APPARATUS FOR DIAGNOSTICS USING INTEGRATED ACOUSTIC ANALYSIS AND OBD DATA

(71) Applicants: GLOBAL SENSE, INC., Solana Beach, CA (US); CNOW, LLC, Whitehall, PA (US)

(72) Inventors: Saeid Safavi, San Diego, CA (US); Thomas D. Ryan, San Diego, CA (US)

(73) Assignee: AGST, INC., Whitehall, PA (US)

(21) Appl. No.: 19/240,868

(22) Filed: Jun. 17, 2025

Related U.S. Application Data
(60) Provisional application No. 63/664,685, filed on Jun. 26, 2024.

(51) Int. Cl. G07C 5/08; G06N 3/044

(52) U.S. Cl. CPC G07C 5/0816; G06N 3/044; G07C 5/0808

(57) ABSTRACT

Various embodiments of a method and apparatus for analyzing the health and status of a vehicle and for generating a health signature that can be used to determine whether the health and status of a vehicle has changed over time. The System comprises an OBD device aboard a vehicle. The System further comprises an acoustic sensor for collecting acoustic data. Data and acoustic detection of events associated with a vehicle are provided to a cloud based AI engine. The engine performs anomaly detection, fault diagnosis and predictive maintenance of the components of the vehicle. Such components include the vehicle's engine or transmission. Analysis and diagnostics regarding other components of the vehicle might also be performed. In some embodiments, a user device running an application allows a user to trigger an analysis of a vehicle connected to the System. Data collected and either be stored as a health signature for comparison to similar data collected at a time in the future, or analyzed by the cloud based AI engine, the results of which form a health signature which is stored.

### CROSS-REFERENCE TO RELATED APPLICATIONS—CLAIM OF PRIORITY

The present application claims priority to U.S. Provisional Application No. 63/664,685, filed Jun. 26, 2024, entitled “Method and Apparatus for Diagnostics using Integrated Acoustic Analysis and OBD Data,” which is herein incorporated by reference in its entirety.

### BACKGROUND

### (1) Technical Field

This disclosure relates combining acoustic data with additional related data to diagnose and detect events and more particularly to use acoustic sensors and artificial intelligence to combine acoustic data with data provided from non-acoustic sources.

### (2) Background

Diagnosing the health and safety of a vehicle is important for anyone that uses the vehicle. However, in most cases, we assume our vehicle is performing both safely and without any significant faults or defects based on our previous use of the vehicle. This is only possible if we have used the vehicle before. In addition, we need to have used it sufficiently frequently to gain sufficient experience with the vehicle to make a reasonable determination that the vehicle is safe, that it is not defective, and is not about to become inoperable. In some cases, we can rely upon our experience with other similar vehicles to make this determination. In fact, most of the time we make this determination without considering the fact that we are doing so. That is, based on our history with our vehicle, we get into our vehicle and assume that it will be safe to operate and that it will not only start and get us to our desired destination, but that it will be operable to return again when we wish to return. When buying a new vehicle, we will not have sufficient historical information about the way the vehicle typically performs to know whether the vehicle is operating without a latent defect that might soon result in a costly repair and possibly lead to an unsafe situation. However, with new vehicles we rely upon the reputation of the manufacturer. In the case of rented vehicles, we rely upon the fact that the entity renting the vehicle provides assurances regarding the reliability of the vehicle.

Nonetheless, there are times when we do not have sufficient historical information to make such a determination and either there is not a sufficiently reliable third party to provide assurance or the stakes are elevated and we wish to attain a more reliable determination of the condition of a vehicle. For example, when purchasing a used vehicle, and in particular when purchasing a used vehicle through an auction, it would be desirable to be able to determine the condition of a vehicle prior to making a bid on that vehicle. In addition, if a defect becomes evident after the sale, it would be desirable to determine whether the defect was present prior to the sale or developed after the sale.

Accordingly, it would be advantageous to provide a system that can accurately determine the condition of a vehicle, predict whether the vehicle has a latent defect that might lead to a costly repair and further determine whether the vehicle is in essentially the same condition as it was just prior to a sale.

### SUMMARY

The presently disclosed System provides a means for analyzing the health and status of a vehicle and for generating a health signature that can be used to determine whether the health and status of a vehicle has changed over time. The System comprises an On-Board Diagnostic (OBD) device aboard a vehicle. The System further comprises an acoustic sensor for collecting acoustic data. The OBD device in some embodiments is an OBDII device. Data and acoustic detection of events associated with a vehicle are provided to a cloud based AI (artificial intelligence) engine. The AI engine performs anomaly detection, fault diagnosis and predictive maintenance of the components of the vehicle. Such components include the vehicle's engine or transmission. Analysis and diagnostics regarding other components of the vehicle might also be performed. In some embodiments, an application (app) running on a user device allows a user to trigger an analysis of a vehicle connected to the System. Data collected is either be stored as a health signature for comparison to similar data collected at a time in the future, or analyzed by the cloud based AI engine, the results of which form a health signature which is stored.

The AI engine comprises a one-dimensional Convolutional Processor and a first RNN (Recurrent Neural Network) for preprocessing of OBD data, including DTC codes. A Feature Extraction Module, a 2-dimensional/3-dimensional Convolutional Neural Network (CNN) and a second RNN are provided for processing acoustic data received from an acoustic sensor located in the vehicle. A Fully Connected Neural Network combines the OBD data, DTC codes and acoustic data to provide a health status output to the user on the user device. By using two processing chains, each designed for processing the particular type of inputs applied, the total operation of the AI engine is optimized for the purpose of providing the health status of the vehicle under the control of a user through a user device running an app, resulting in an improved AI engine for analyzing and diagnosing faults and failure conditions in a vehicle and for generating unique health signatures representing the health and status of a vehicle.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is a simplified diagram showing the basic components of one embodiment of the System.

FIG. 2 is an illustration of some of the components of the System that reside in the vehicle.

FIG. 3 is an illustration of a vehicle engine with an ADCM fixed to it.

FIG. 4 is a simplified flowchart of the process used to collect OBD and acoustic data and provide that data to an RPU operating in an internet cloud.

FIG. 5 is a more detailed illustration of the components of the System.

FIG. 6 is a flowchart of one process that can be used in accordance with one embodiment to train the 1D convolutional processor.

FIG. 7 is a flowchart of a method performed by the RPU.

FIG. 8 is a flowchart of a method performed by the RPU after training is complete.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The presently disclosed method and apparatus (which, for the sake of brevity, is referred to throughout this document as “the System”) provides a means for determining the condition of a vehicle at a particular point in time and further for comparing the condition of a vehicle at a future point in time with the condition of that vehicle at a previous point in time. For example, the System provides a means for determining the condition of a vehicle at a time of sale and comparing the condition at the time of sale to the condition of that vehicle at a future time to determine whether a latent defect or fault existed prior to the sale or developed after the sale.

It will be clear to those of ordinary skill in the art that the System has broader applicability than simply determining the condition of a vehicle for the purposes of verifying the condition at a time of sale and comparing that with the condition of the vehicle at a future time. For example, the System can be used to determine the condition of a vehicle on an ongoing, real-time basis and provide information to the user of any change in the status of the vehicle that might indicate that an operational fault has arisen or is imminent. Nonetheless, for the purpose of describing the nature and operation of the System, this disclosure focuses on the use of the System to assist in validating the condition of a vehicle that has been sold at auction. Furthermore, the System can be used with equipment other than vehicles, such as construction equipment, manufacturing equipment, etc.

In accordance with some embodiments of the System, the System coordinates the collection and combination of data received from an On-Board Diagnostic (OBD) device aboard a vehicle and acoustic data collected by an acoustic sensing module. The OBD device in some embodiments is an OBD device operating in accordance with the industry standard commonly known as OBDII.

Some of the current standards related to OBD systems include:

### Legislated Protocols:

ISO 15765 (CAN),
ISO 14230 (Keyword Protocol 2000, KWP2K),
ISO 9141 (Asian, European, Chrysler vehicles),
SAE J1850 VPW (GM vehicles),
SAE J1850 PWM (Ford vehicles),
SAE J1939 (Heavy Duty vehicles), and
SAE J1979-3 (Zero Emission Vehicles).

### Non-Legislated Protocols:

ISO 11898 (raw CAN),
SAE J2818,
SAE J2411 (GMW3089,
Single Wire CAN, GMLAN), and
Ford MS-CAN (Medium Speed CAN)

It will be understood that the above noted protocols are provided merely as examples of protocols that are useful in understanding OBD systems generally, and more particularly to understanding of the System and are not meant to limit the scope or applicability of the System. Furthermore, it should be understood for this disclosure that other protocols defining a system for sensing and reporting the status of a vehicle may be used as well.

OBD Data and acoustic data associated with a vehicle are provided to an AI (artificial intelligence) engine. The AI engine performs anomaly detection, fault diagnosis and predictive maintenance of the components of the vehicle based on the OBD data and acoustic data. Such components include the vehicle's engine or transmission. Analysis and diagnostics regarding other components of the vehicle might also be performed.

In some embodiments, the System uses an AI model to detect potential operational faults in the vehicle, based on a generated audible acoustic signature associated with a vehicle. OBD data is used to enhance the model accuracy and the ability to perform a predictive diagnostic process. Furthermore, in some embodiments, the System provides a novel engine fingerprinting method that merges the acoustic signature of the vehicle with its OBD data. This approach enables the detection of any significant changes in the vehicle's health status, both before and after a sales transaction. The use of the System provides information to assist with dispute resolution processes, such as arbitration between auto auctioneers and those that have purchased vehicles from the auctioneer, as well as between purchasers and other businesses by allowing the presale fingerprint and the post-sale fingerprint to be compared to one another.

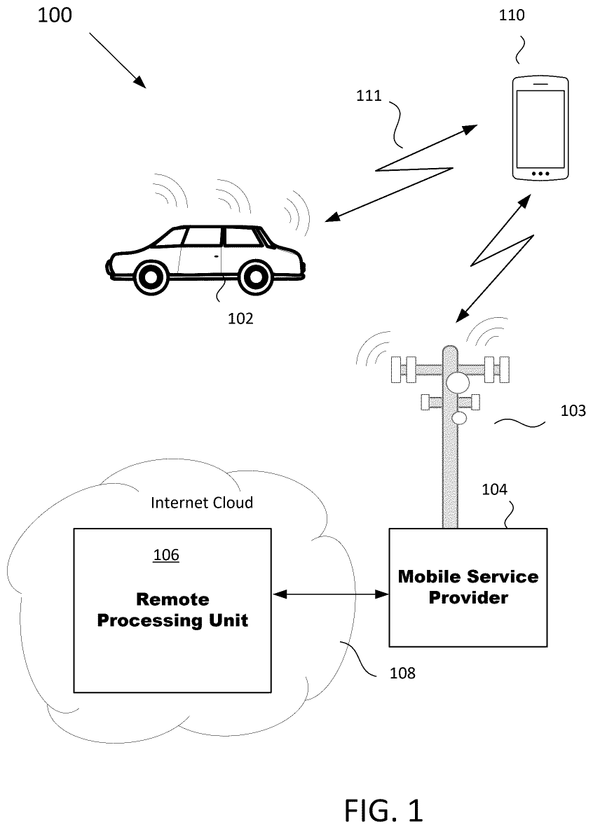

FIG. 1 is a simplified diagram showing the basic components of one embodiment of the System 100. In this embodiment, one vehicle 102 is shown. However, it will be clear to those skilled in the art that the System may comprise just one vehicle, or alternatively, a relatively large number of vehicles.

The vehicle 102 communicates with external resources over a wireless network, such as a cellular network, private enterprise network, LAN (Local Area Network), WAN (Wide Area Network), etc. In some embodiments, an application (i.e., an “app”) running on a user device 110, such as a smart phone, tablet, laptop computer, desktop computer or other such user device, provides an interface between resources accessed through the internet (e.g., in “the cloud” 108) and the resources within the vehicle 102. In some embodiments, the app in the user device 110 communicates with the resources in the vehicle 102 over a short range communication link 111, such as Bluetooth, WiFi or another such wireless protocol. In other embodiments, other wireless communication interfaces may be used to allow the resources within the vehicle 102 to communicate with the user device 110. It should be noted that in other embodiments, wired connections are used to communicate between components.

The app in the user device 110 connects with a base station/access point (BS/AP) 103 of a mobile service provider 104 (such as a Mobile Service Operator (MNO) like Verizon or Sprint), allowing the app to access an RPU (Remote Processing Unit) 106 based in the cloud 108. The app allows information that is collected on board the vehicle 102 to be transmitted to and remotely processed by the remote resources, such as the RPU 106. In addition, in some embodiments, the app allows a user to interact with the data collection process, as will be detailed further below.

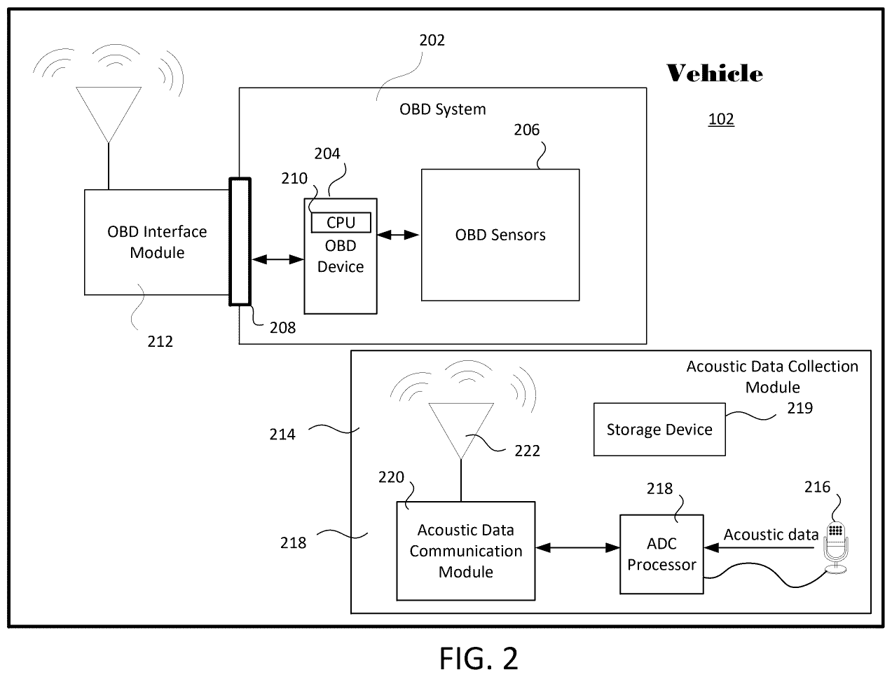

FIG. 2 is an illustration of some of the components of the System 100 that reside in the vehicle 102. The vehicles 102 of the System have an OBD system 202 comprising an OBD device 204 that communicates with OBD sensors 206 in the vehicle to collect OBD data from the OBD sensors 206. Such OBD systems are typically provided in cars and trucks by the manufacturer as standard features of the vehicle. The OBD system 202 comprise sensors that provide live sensor data to the OBD device 204. Typically, the sensor data is in form of electrical signals received by the OBD device 204 from the sensors 206. In some embodiments, such live sensor data is made available to devices that are external to the OBD system 202 through a OBD port 208, such as an OBDII port.

In some embodiments of the System, the OBD system 202 comprises a central processing unit (CPU) 210 that processes the sensor data. In some embodiments, the CPU 210 issues Diagnostic Trouble Codes (DTC codes) (also referred to as engine fault codes) that can be output through the OBD port 208 to assist a user with identifying and diagnosing malfunctions in a vehicle. When a vehicle's OBD system detects a problem, the OBD system 202 issues a trouble code that corresponds with the detected problem. OBD systems can vary from manufacturer to manufacturer. The well-known OBD-II industry standard provides a protocol and configuration for systems for both light-duty and medium-duty vehicles built from 1996 onward. The Society of Automotive Engineers (SAE) International created a list of standard DTC codes for all manufacturers. While conventional OBD systems have several sensors, they typically do not have audio sensors that can detect and analyze sounds (i.e., acoustic data) associated with events that occur during malfunctions, such as when the engine or a transmission exhibit an operational failure. Some vehicles have a “knock” sensor that is provided inside the engine to detect vibration that might be indicative of engine knock. Furthermore, while the sensors in prior art systems are helpful in diagnosing several operational issues, such sensors do not provide sufficient information to accurately diagnose and detect many other faults. Nor can the prior art OBD systems predict a need for maintenance. Some of the most difficult faults for current OBD systems to monitor are maintenance issues related to the vehicle engine and transmission.

In accordance with some embodiments of the System, an OBD Interface Module 212 is plugged into (or otherwise electrically coupled to) the OBD port 208. The OBD Interface Module 212 provides both the ability to receive and transmit DTC codes and live OBD data to an external device, such as the user device 110. In addition, the OBD Interface Module can be used to configure the OBD device 204. For example, the OBD device 204 can be configured to provide particular DTC codes and live OBD data from particular sensors 206 within the vehicle 102. In some embodiments of the System, the OBD Interface Module is an off-the-shelf device, such as the Midtronics Wi-Fi OBD II Interface for GR8 & HYB-1000 Models (CVG-WIFI).

The following is a partial list of some of the operational issues that OBD data can assist in detecting and diagnosing:
engine misfires;
vehicle speed and idling control problems;
engine overheating;
efficient burning of oxygen;
manifold air flow; and
fuel trim.

A combination of OBD sensor data, including camshaft and crankshaft position sensors, fuel injection sensors, short-term and long-term fuel trim sensors and others can be used to assist in detecting and diagnosing engine knock and other issues related to misfires.

Also present within the vehicle 102 is an Acoustic Data Collection Module (ADCM) 214. The ADCM 214 comprises an acoustic sensor 216, such as a microphone, an ADC (Acoustic Data Collection) Processor 218, a storage device 219, an ADCOM (Acoustic Data Communication Module) 220 and an antenna 222.

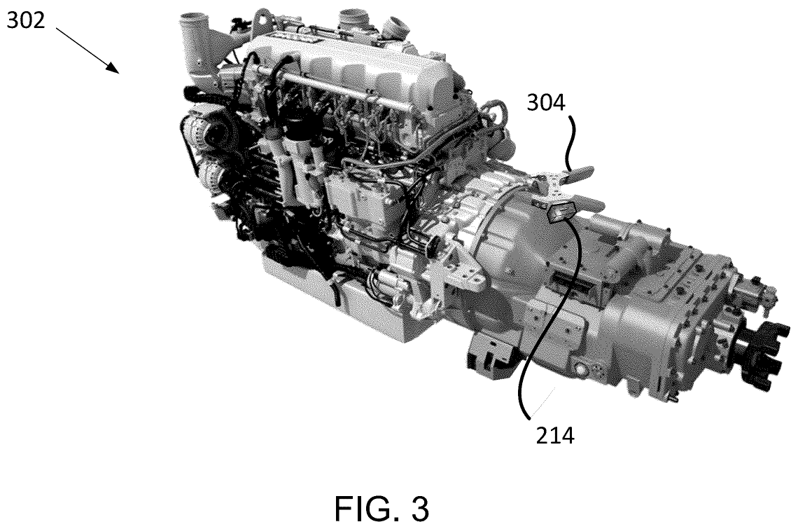

FIG. 3 is an illustration of a vehicle engine 302 with an ADCM 214 fixed to it. In the embodiment shown, the ADCM 214 is physically attached to a clamp 304. A user attaches the clamp 304 to the engine at a point that provides the desired location for capturing the acoustic data that is sought by the user.

While OBD data provides valuable insights into a vehicle's powertrain health and the potential issues with the vehicle, interpreting this data often requires expertise. Furthermore, the data that is provided by the OBD system 202 may not be sufficient to accurately detect and diagnose important operational performance issues. By combining the OBD data collected by the OBD system with acoustic data collected by the ADCM 214, more accurate detection and diagnosis can be performed.

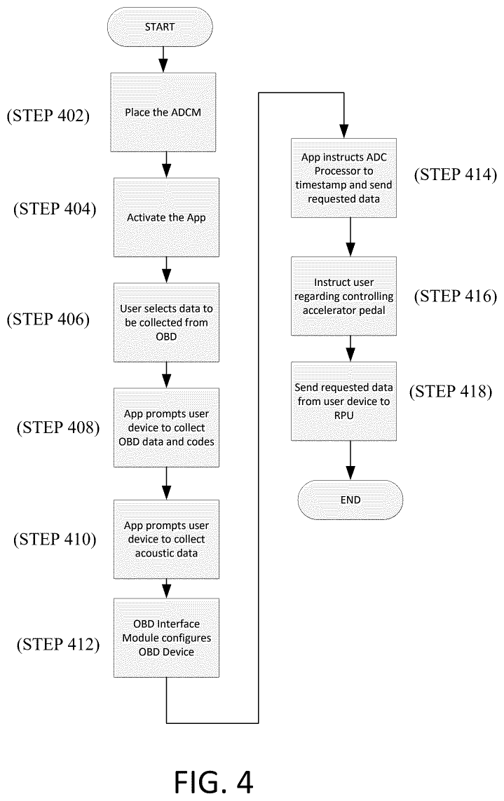

FIG. 4 is a simplified flowchart of the process used to collect OBD and acoustic data and provide that data to an RPU 106 operating in an internet cloud.

Collecting and combining the OBD and acoustic data is done with the assistance of the app running on the user device 110. Initially, the user (e.g., a mechanic or other person familiar with the data collection process) places the ADCM 214 at a location from which the user wishes to acquire acoustic data (STEP 402). It should be noted that in some embodiments, multiple ADCMs 214 provide data concurrently.

Next, the user activates the app running on the user device 110 (STEP 404). The user then identifies the particular data to be collected by the OBD system 202 (STEP 406). The app prompts the user device 110 to send wireless communications to the OBD Interface Module 212 that allow the OBD Interface Module 212 to configure the OBD Device 204 to collect the desired data and to provide the requested DTC codes (STEP 408). The app also prompts the user device 110 to send wireless communications to the ADCOM 220 to start collecting acoustic data from the acoustic sensor 216 (STEP 410).

In response to communications sent from the user device 110 under the control of the app and subsequently received by the OBD Interface Module 212, the OBD Interface Module 212 configures the OBD Device 204 to timestamp and provide the requested data to the user device 110, including live OBD data and DTC codes (STEP 412).

Concurrently, in response to communications sent from the user device 110 under the control of the app and subsequently received by the ADCOM 220, the ADC Processor 218 begins timestamping data received by the ADC Processor 218 from the acoustic sensor 216. The timestamped data is sent to the user device 110 (STEP 414). By timestamping the data collected by both the ADC Processor 218 and the OBD Device 204, the app running in the user device 110 can coordinate and combine the data, as will be explained in greater detail below.

In some embodiments of the System 100, the user app instructs the user to start the engine, rev the engine (i.e., control the accelerator pedal in a prescribed manner to control the engine during data collection), hold the accelerator in a prescribed position for a prescribed amount of time and then change the accelerator position to cause the engine to operate in a manner that allows the most meaningful data to be collected. The particular instructions that the app provides to the user depends upon the data to be collected and the particular vehicle functions to be checked (i.e., the particular faults to be detected/diagnosed).

Upon receiving all of the requested OBD and acoustic data in the user device 110, the app transmits the data to the RPU 106 in the cloud over the wireless communication link, such as a cellular network (STEP 418).

In some embodiments of the System, the RPU 106 is a cloud based processor that is capable of performing complex artificial intelligence processing. The transmitted acoustic features that emanate from the engine (e.g., engine sounds, transmission sounds and other sounds generated by vibrations due to engine and/or transmission activity, as well as other components of the vehicle) and data received from an OBD system are provided the PRU 106 as AI inputs to the AI engine.

It should be noted that throughout this disclosure, AI denotes systems capable of adaptive learning, predicated on the analysis of input/output data compilations. The output from the AI engine provides diagnostic insights pertaining to the engine's condition, such as indications of engine knock, tappet noise, or other distinct mechanical malfunctions.

In accordance with some embodiments of the System, an AI engine comprises modules that are optimized to identify critical engine anomalies by analyzing a combination of acoustic inputs and OBD data. In some embodiments of the System, the AI engine is calibrated to detect dynamic acoustic profiles associated with various engine maladies. In some such embodiments of the System, these acoustic profiles are augmented by the real-time OBD data and DTC codes.

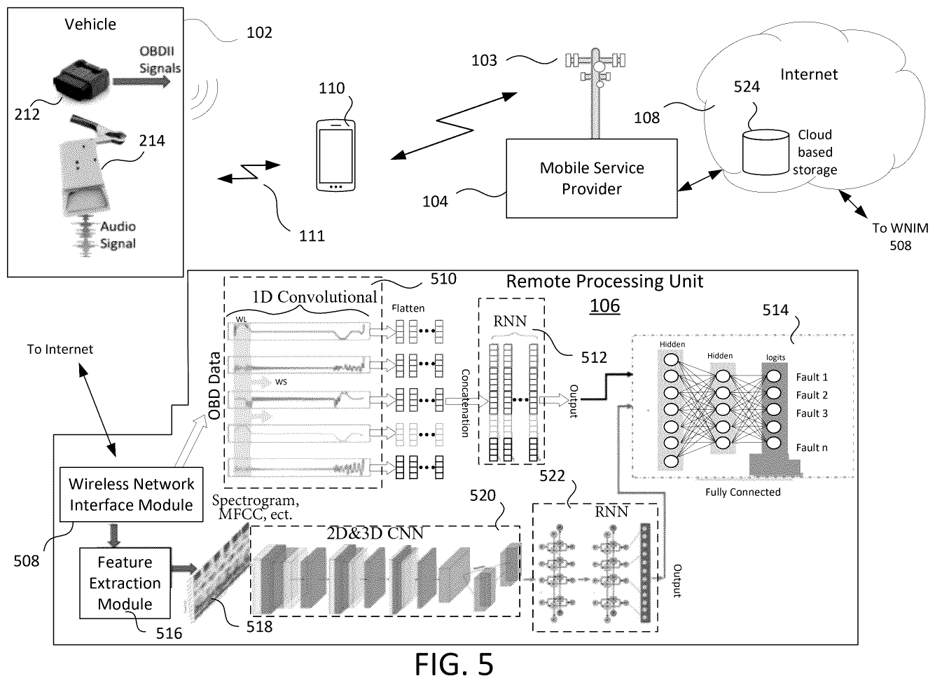

FIG. 5 is a more detailed illustration of the components of the System 100. As noted in the above discussion of FIG. 2, in some embodiments of the System 100, the OBD device 204 receives live OBD data from a plurality of OBD sensors 206. The CPU 210 within the OBD device 204 generates DTC codes based on the live OBD data. The OBD device 204 provides the live data and the DTC codes to the OBD Interface Module 212. In some embodiments, the OBD Interface Module 212 time stamps both the live OBD data and DTC codes. The OBD Interface Module 212 communicates with the user device 110 by a short range wireless link 111, such as Bluetooth or WiFi.

Concurrent with the collection of the OBD data and generation of the DTC codes, the ADC Processor 218 collects acoustic data from the acoustic sensor 216. In some embodiments, the ADC Processor 218 time stamps the acoustic data. The time stamped acoustic data is then provided to the ADCOM 220 for transmission to the user device 110. In some embodiments, similar to the OBD Interface Module 212, the ADCOM 220 communicates with the user device 110 over a short range communication link.

However, in other embodiments, other means of communication can be used to communicate the ODB data and the acoustic data to the user device 110. For example, in some embodiments, the ADCM 214 and the OBD Interface Module 212 are wired to a transceiver (not shown) that provides a communication link to the user device 110. Such a transceiver can use any wireless means to communicate with the user device 110. In other embodiments, both the ADCM 214 and the OBD Interface Module 212 are coupled by a wired connection to a custom user interface device (not shown). The custom user interface device is capable of communicating over a local network or a cellular network to access the RPU 106. It should be noted that those elements shown in multiple figures and associated with the same reference designation are essentially the same. For example, the RPU 106 shown in FIG. 5 is essentially the same as the RPU 106 shown in FIG. 1.

Furthermore, in other embodiments, time stamps are associated with the OBD live data, DTC codes and acoustic data by the app running in the user device 110.

In the embodiment shown in FIG. 5, the user device 110 accesses the RPU 106 through a BS/AP 103 an MSO (Mobile Service Operator) 104 to access the MSO's cellular network. The MSO 501 provides a connection to the internet 506 for the user device 110. A WNIM (Wireless Network Interface Module) 508 within the RPU 106 provides access to internet 506, and thus to the user device 110. The WNIM 508 receives the OBD data and the acoustic data from the user device 110.

A first processing branch comprises a 1D convolutional processor 510 coupled to an OBD RNN (Recurrent Neural Network) 512. A second processing branch comprises a feature extraction module 516 that outputs a spectrograph 518 that is coupled to a 2-dimensional/3-dimensional acoustic CNN (Convolutional Neural Network) 520. The output of the acoustic CNN 520 is then coupled to an acoustic data RNN 522. The output of the acoustic data RNN 522 and the outputs of the OBD RNN 512 are then both provided as inputs to a Fully Connected Neural Network 514.

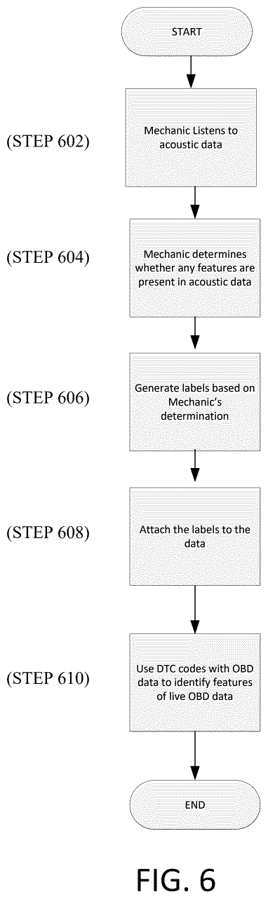

FIG. 6 is a flowchart of one process that can be used in accordance with one embodiment to train the 1D convolutional processor 510. In some embodiments, as part of the training of the System 100, a skilled automotive mechanic listens to acoustic data prior to presenting the data to the RPU 106 (STEP 602). The mechanic determines whether any relevant features are present in the acoustic data (STEP 604). That is, the mechanic makes a determination as to whether the acoustic data indicates whether the vehicle is operating properly, has a potential malfunction or is clearly malfunctioning, and potentially, what the nature of the malfunction. The mechanic then generates labels based on the sounds the mechanic hears (STEP 606). The mechanic attaches the labels to the acoustic data based on the mechanic's skilled observation (STEP 608). Such labels categorize the condition that the mechanic determines to exist based on listening to the acoustic data and using his experienced ear. In some embodiments, the labeling of acoustic data for training purposes and the use of the training data can be done prior to using the System 100 in order to allow real time diagnostics on a vehicle 102. Live OBD data collected from the OBD sensors, labels associated with the OBD data and DTC codes are used to identify features of the live OBD data that are correlated with operational conditions indicated by the DTC code (both normal operation and faulty operation) and the labels provided by the mechanic (STEP 612).

Such features might include time-domain features, such as (1) mean, (2) standard deviation, (3) skewness, (4) root-mean-square, (5) kurtosis, etc. Features might also include frequency-domain features, such as (1) power bandwidth, mean frequency, peak value, peak frequencies, harmonics, etc. Features might still further include time-frequency domain features, such as (1) spectral entropy, (2) spectral kurtosis, etc.

Training the convolutional processor 510 allow features of (i.e., patterns that exist within) the live OBD data to be extracted from the live OBD data. Accordingly, the DTC codes are used together with the live OBD data and the mechanic generated labels to train the 1D convolutional processor 510 to identify the features for which the 1D convolutional processor 510 is being trained. Through the process of training the 1D convolutional processor 510, the particular features that are relevant will be selected.

In similar fashion, 512 the acoustic CNN 520, the OBD RNN 512, the feature extraction module 516, the acoustic CNN 520 and the acoustic data RNN 522 and the Fully Connected Neural Network 514 can be trained either as separate operations or by training the complete RPU 106 as a single processing system. That is, training data can be provided as the input to each of the acoustic CNN 520, the OBD RNN 512, the feature extraction module 516, the acoustic CNN 520 and the acoustic data RNN 522 and the Fully Connected Neural Network 514, rather than having each provide its output to the next. The output of each can then be feedback to determine an error to train each processing element independently. The output of each component 510, 512, 516, 520, 514 is then used to determine the progress of the training of that component 510, 512, 516, 520, 514 prior to training the full RPU 106.

Alternatively, training data can be provided to the RPU 106 and the results at the output of the Fully Connected Neural Network provided as feedback to determine the progress of the training.

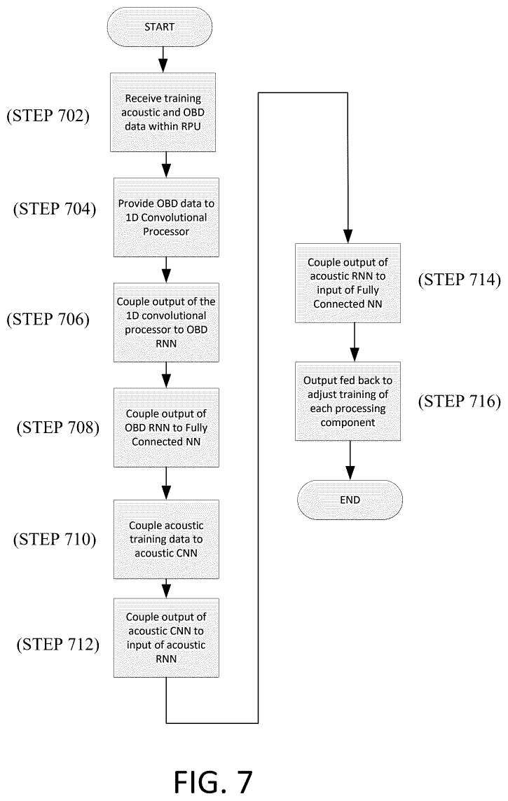

FIG. 7 is a flowchart of a training process implemented in accordance with embodiments of the system in which the RPU 106 is trained as a single processing unit. In such embodiments, training data representing known conditions of a vehicle are presented at the input of the RPU 106 (STEP 702). The training data include samples of live OBD data (or simulated live OBD data), DTC codes that correlate with the samples of the live OBD data and acoustic data (either samples of data taken from vehicles of known condition or simulated data representing such acoustic data). The training OBD data and training DTC codes are then provided to the input of the 1D convolutional processor 510 (STEP 704). The output of the convolutional processor is coupled to the OBD RNN 512 (STEP 706). The output of the OBD RNN 512 is coupled to a first input of the Fully Connected Neural Network 514 (STEP 708). Concurrently, the acoustic training data is coupled to the input of the acoustic CNN 520 (STEP 710). The output of the acoustic CNN 520 is coupled to the input of the acoustic data RNN 522 (STEP 712). The output of the acoustic data RNN 522 is then coupled to a second input of the Fully Connected Neural Network 514 (STEP 714). The output of the Fully Connected Neural Network 514 is then feedback and used to adjust the training of each of the components 510, 512, 516, 520, 514 of the RPU 106 (STEP 716). In some embodiments, this training can be done through the app running on the user device 110 which provides access to a set of training data that is stored in a cloud based storage unit 524. Alternatively, such training can be done by providing training data directly to the WNIM 508 from the internet.

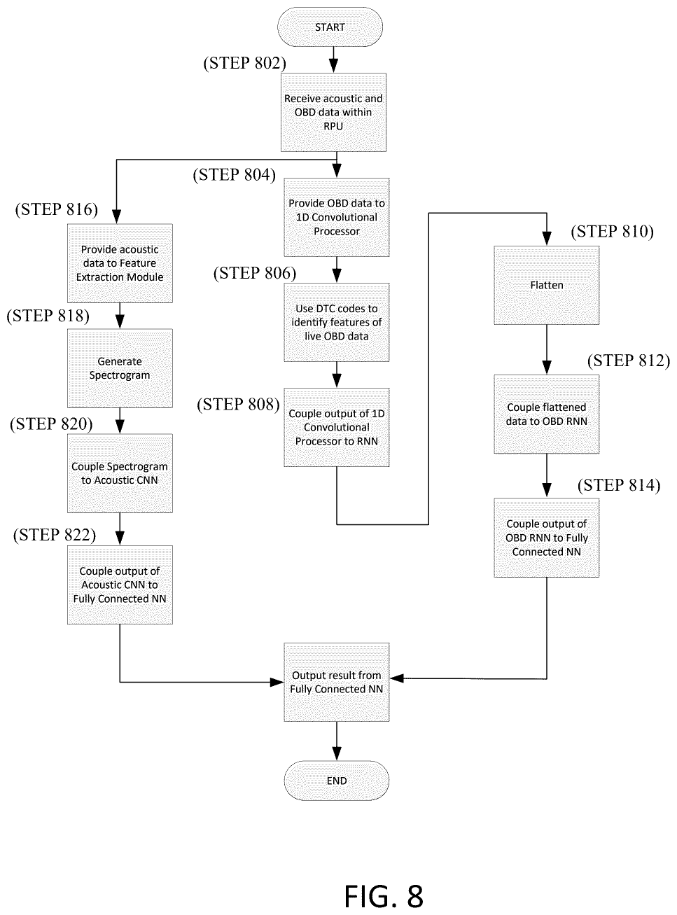

FIG. 8 is a flowchart of a method performed by the RPU 106 after training is complete. Initially, the acquired OBD data and acoustic data are each provided to different inputs to the RPU 106 (STEP 802). The received OBD data and acoustic data are initially processed through different preprocessing algorithms before being combined for final processing. The OBD data is coupled to the 1-dimensional (1D) convolutional processor 510 (STEP 804). The 1D convolutional processor 510 performs a first stage of analysis of the OBD data. The 1D convolutional processor 510 uses the DTC codes to identify features of the live OBD data (STEP 806). This reduces the complexity of the OBD data and limits the raw OBD data prior to providing inputs to the OBD RNN 512. The output of the 1D convolutional processor will be presented with those features to the RNN OBD 512 (STEP 808). That is, the 1D convolutional processor 510 detects patterns that correlate with particular operational conditions. In addition, the 1D convolutional processor 510 deemphasizes features not correlated with the operational conditions of interest, thereby filtering and reducing the complexity of the data output provided to the OBD RNN 512. In some embodiments, these features include both frequency domain and time domain features. The use of the 1D convolutional processor 510 makes it easier for the OBD RNN 512 to identify conditions of interest by eliminating data that is minimally helpful and thus reducing the size of the input data set provided to the OBD RNN 512.

The OBD data is then flattened and concatenated before being coupled to the OBD RNN 512 (STEP 810). Flattening reduces the number of dimensions. For example, data that is in a two dimensional format is reduced to a one dimensional array. Concatenating reduces several arrays of flattened data to a relatively smaller number of arrays based on commonalities in the arrays. Once flattened and concatenated, the output of the convolutional processor 510 is coupled to the input of the OBD RNN 512 (STEP 812). The output of the OBD RNN 512 is then coupled to the Fully Connected Neural Network 514 (STEP 814).

The acoustic data collected by the ADCM 214 and communicated through the user device 110 and the internet connection to the WNIM 508 is coupled from the WNIM 508 to the Feature Extraction Module 516 (STEP 816). The acoustic data is typically a more complex waveform than the OBD sensor data. Furthermore, the OBD data includes data collected from a plurality of OBD sensors 206, whereas in some embodiments, the acoustic data is collected by one acoustic sensor 216. Therefore, processing of the acoustic data is performed differently from that of the OBD data. In some embodiments, the Feature Extraction Module 516 first transforms the acoustic data into a spectrogram 518 (i.e., a visual representation of the spectrum of frequencies of a signal as it varies with time) (STEP 818). In some embodiments, this is done by transforming time domain acoustic signals into frequency domain acoustic signals (such as by means of an FFT (fast Fourier transform) over selected periods of time. In some embodiments, these periods of time are consecutive, but have at least some overlap, forming a series of overlapping windows. The resulting frequency domain data is then stitched together to form the spectrogram that is output from the Feature Extraction Module 516. In other embodiments, the acoustic data is transformed into an MFE (Mel Filter-bank Energies) or MFCC (Mel Frequency Cepstral Coefficients) format. In still other embodiments, some combination of these formats are used to provide the acoustic data in a format that is most useful for identifying features of interest and distinguishing those features for features that are not of interest.

The output of the Feature Extraction Module 516 is provided to the acoustic CNN 520 (STEP 820). The acoustic CNN 520 reduces the complexity of the data by performing a first level analysis of the data and outputting data that focuses on only the features that are most likely to be significant in the further processing to be done by the acoustic data RNN 522. The acoustic data RNN 522 is trained to identify fault conditions based only on the acoustic data presented to the Feature Extraction Module 516.

The output of the acoustic data RNN 522 is coupled to the Fully Connected Neural Network 514 (STEP 822) to be combined with the output of the OBD RNN 512. By reducing the number of inputs to the Fully Connected Neural Network 514, the two RNNs 512, 522 allow the he Fully Connected Neural Network 514 to effectively and efficiently use both the acoustic data, the OBD live data and the DTC codes to detect and diagnose a range of conditions in the vehicle 102 under the control and direction of a user through the user device 110. In embodiments, the Fully Connected Neural Network 514 outputs information that can directly identify the condition of the vehicle form which the input data was taken. In other embodiments, the output of the Fully Connected Neural Network 514 is data indicative of the condition of the vehicle, and from which the condition of the vehicle can be derived. The output of the Fully Connected Neural Network 514 can be coupled to the user device 110, to a device within the internet, or to another dedicated device intended for the purpose of displaying the information to a user or other interested party or otherwise communicating the information to such user or interested party, such as a record keeper that maintains records of the condition of vehicles.

In addition to providing a means for detecting and diagnosing issues in a vehicle, the System is suited for use in generating a health signature that can be stored for later use. At a time in the future, the health signature can be regenerated and compared to the earlier generated health signature to determine whether the health status of the vehicle has changed. In some embodiments, the health signature consists of a full set of data (i.e., OBD live data, DTC codes and acoustic data) taken at a particular point in time. In such embodiments, the health signature can be applied to the RPU 106 to determine the health status of the vehicle 102. In other embodiments, the health signature is the output of the RPU 106 which is stored and regenerated at a later time.

Such health signatures are useful for determining whether the status of a vehicle has changed after the vehicle has been sold. This is particularly useful when a vehicle is sold with little or no opportunity to perform a full operational inspection of the vehicle before the sale.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for analyzing and diagnosing operational conditions of a vehicle, comprising:
a) a one-dimensional convolutional processor having inputs for receiving OBD (On-Board Diagnostic) data and outputs for outputting preprocessed results that identify features of interest of the OBD data;
b) a OBD recombinant Neural Network (RNN) having inputs, coupled to the outputs of the one-dimensional processor, to receive the results of the one-dimensional convolutional processor and outputs for outputting results that indicate the probability of particular fault conditions based on the OBD data input to the one-dimensional convolutional processor;
c) a fully connected neural network having a set of OBD inputs coupled to the outputs of the OBD RNN for receiving the results of the OBD RNN and a set of acoustic inputs;
d) a feature extraction module having inputs configured to receive acoustic data and outputs for outputting a frequency domain output;
e) a multi-dimensional CNN (Convolutional Neural Network) having inputs coupled to the outputs of the feature extraction module and outputs for outputting results that identify features that are indicative of fault conditions based on the received acoustic data input to the feature extraction module; and
f) an acoustic RNN having inputs coupled to the outputs of the multi-dimensional CNN for receiving the results provided by the multi-dimensional CNN and output configured to output results indicative of the probability of particular fault conditions, the outputs being coupled to the acoustic inputs of the fully connected neural network;
wherein the fully connected neural network combines the results output from the OBD RNN and the results output from the acoustic RNN to determine the probability of a fault condition in a vehicle from which the OBD data and the acoustic data was collected.
